(19) United States
(12) Patent Application Publication
(10) Pub. No.: US 2009/0219858 A1
(43) Pub. Date: Sep. 3, 2009

(54) Method and System for Transmitting a Signal to a Communication Device in a Cellular Communication System

(75) Inventors: Ying Chang Liang, Singapore (SG); Yan Wu, Singapore (SG); Sumei Sun, Singapore (SG); Woon Han Chin, Singapore (SG); Wing Seng Leon, Singapore (SG); Po Shin Francois Chin, Singapore (SG)

Correspondence Address: CHOATE, HALL & STEWART LLP, TWO INTERNATIONAL PLACE, BOSTON, MA, 02110, US

(73) Assignee: AGENCY FOR SCIENCE, TECHNOLOGY AND RESEARCH, Singapore (SG)

(21) Appl. No.: 12/092,968

(22) PCT Filed: Nov. 7, 2006
(86) PCT No.: PCT/IB06/03134

§ 371 Date: Nov. 14, 2008

Related U.S. Application Data
(60) Provisional application No. 60/734,080, filed on Nov. 7, 2005.
(60) Provisional application No. 60/734,117, filed on Nov. 7, 2005.

(51) Int. Cl. H04L 27/28; H04B 7/00

(52) U.S. Cl. 370/328; 455/422.1

(57) ABSTRACT

A method for transmitting a signal to a communication device in a cellular communication system is provided. The method comprises transmitting a signal using a first antenna being provided in a first sector of the cellular communication system, and transmitting another signal using a second antenna being provided in a second sector of the cellular communication system, wherein the first sector at least partially overlaps the second sector, wherein the signal transmitted by the second antenna is a cyclic delayed version of the signal transmitted by the first antenna.

The present application claims the benefit of U.S. provisional applications 60/734,117 (filed on 7 Nov., 2005) and 60/734,080 (filed on 7 Nov., 2005), the entire contents of which are incorporated herein by reference for all purposes.

The present invention refers to a method for transmitting a signal to a communication device in a cellular communications system, as well as to the respective system.

Due to the advent of wireless communication technology, frequency spectrum has become an extremely precious commodity. It is becoming increasingly difficult to obtain available frequency spectrum for new wireless communication technologies and applications. It is therefore an objective nowadays to maximize the use of existing allocated frequency spectrum.

An approach which can be used to achieve this objective of maximizing the use of all existing allocated frequency spectrum is sectorization. Sectorization is typically used in conjunction with cellular technology, to increase system capacity for wireless systems. Sectorization is implemented typically using directional antennas.

In the case where all sectors within the cell make use of the same frequency band, frequency planning among the sectors is not required. However, communication devices at the edge of sectors will suffer from severe inter-sector interference, as they may receive signals from more than one sector antenna.

This problem described earlier, where communication devices at the edge of sectors will suffer from inter-sector interference, is addressed by the method and system as defined in the respective independent claims of the present application.

In a first aspect of the invention, a method of transmitting a signal to a communication device in a cellular communication system is provided, comprising transmitting a signal using a first antenna being provided in a first sector of the cellular communication system, and transmitting another signal using a second antenna being provided in a second sector of the cellular communication system, wherein the first sector at least partially overlaps the second sector, wherein the signal transmitted by the second antenna is a cyclic delayed version of the signal transmitted by the first antenna.

Embodiments of the invention emerge from the dependent claims.

In one embodiment, the communication device may be, but is not limited to, a radio communication device, a terminal communication device or a Consumer Premise Equipment device. A radio communication device, for example, may be, but is not limited to, a mobile radio communication device, a satellite radio communication device, or a mobile radio base station.

In one embodiment, the signal transmitted by the first antenna may be cyclic shifted in order to obtain the cyclic delayed version of the signal transmitted by the first antenna, to be transmitted on the second antenna.

In one embodiment, the signal transmitted by the second antenna may be phase shifted in order to obtain the cyclic delayed version of the signal transmitted by the first antenna, to be transmitted on the second antenna.

In one embodiment, a preamble and/or a pilot sequence may be inserted into the signal transmitted by the second antenna. In another embodiment, a scrambling code may be added to the signal transmitted by the second antenna.

As used herein, the preamble refers to a predefined sequence, typically located at the header of a message or the start of a transmission signal. The preamble, for example may be used for, but is not limited to, signal synchronization, signal calibration, channel estimation, adaptive gain control convergence, diversity selection, timing acquisition, and coarse frequency acquisition at the receiver.

The pilot sequence, as used herein, refers to a predefined sequence, typically located at predetermined parts of a message or a signal. The pilot sequence, for example may be used for, but is not limited to, channel estimation and fine frequency acquisition.

The scrambling code, as used herein, refers to a predefined sequence, added to a signal, typically used to differentiate the signals in one cell of a cellular communication system from its neighboring cell.

In one embodiment, a channel estimation may be carried out. In this embodiment, the channel estimation provides the benefit of additional diversity, which helps to reduce the effects of inter-sector interference on the signal received. This will in turn result in a better overall system performance.

In one embodiment, a multiple access transmission technology is used. In another embodiment, the multiple access transmission technology may be selected from a group of multiple access transmission technologies consisting of time division multiple access, frequency division multiple access, code division multiple access, or orthogonal frequency division multiple access.

For example, in one embodiment, the cellular communication system may be, but is not limited to, the proposed IEEE 802.22 wireless regional area network (WRAN) system [1]. The proposed WRAN system operates in the frequency in the very high frequency (VHF) and/or the ultra high frequency (UHF) frequency band between 47 MHz and 910 MHz, and uses the orthogonal frequency division multiple access (OFDMA) multiple access transmission technology.

In a second aspect of the invention, a system for transmitting a signal to a communication device in a cellular communication system is provided, comprising a plurality of antennas and a signal transmission device. The signal transmission device comprises a first signal generator for generating a signal to be transmitted using a first antenna being provided in a first sector of the cellular communication system, and a second signal generator for generating a signal to be transmitted using a second antenna being provided in a second sector of the cellular communication system, wherein the first sector at least partially overlaps the second sector, wherein the signal transmitted by the second antenna is a cyclic delayed version of the signal transmitted by the first antenna.

In one embodiment, the signal transmission device in the system provided further comprising an orthogonal frequency division multiple access (OFDMA) modulator, and a cyclic delay unit, wherein the cyclic delay unit is used to generate the cyclic delayed version of the signal transmitted by the first antenna, for transmission on the second antenna.

In one embodiment, the cyclic delay unit is a cyclic shift device. In another embodiment, the cyclic shift device may be arranged such that the signal to be transmitted on the second antenna is processed by the orthogonal frequency division multiple access (OFDMA) modulator before being processed by the cyclic shift device.

In one embodiment, the cyclic delay unit is a phase shifter device. In another embodiment, the phase shifter device may be arranged such that the signal to be transmitted on the second antenna is processed by the phase shifter device before being processed by the orthogonal frequency division multiple access (OFDMA) modulator.

In one embodiment, the system for transmitting a signal to a communication device in a cellular communication system provided further comprises a pilot sequence generator, and a preamble generator. In another embodiment, the system for transmitting a signal to a communication device in a cellular communication system provided further comprises a scrambling code generator.

Illustratively, the signal transmission process in a sectorized cellular communication system is analyzed in order to provide suitable means for a communication device located in an area where coverage of two sectors is overlapping, in order to be able to receive the signal transmitted to it. Accordingly, a signal is transmitted to the communication device using a first antenna in a first sector of the cellular communication system and an additional signal is transmitted to the communication device using a second antenna in a second sector of the cellular communication system.

The additional signal transmitted to the communication device using a second antenna in a second sector of the cellular communication system is not the same signal as the signal transmitted to the communication device using a first antenna in a first sector of the cellular communication system, but a cyclic delayed version of it. With the aid of this additional signal, the communication device is able to perform a signal processing to reduce the inter-sector interference, and hence, able to receive the signal transmitted to it.

The embodiments which are described in the context of the method transmitting a signal to a communication device in a cellular communication system provided, are analogously valid for the system.

FIG. 1 shows a cellular communication system according to an embodiment of the invention.

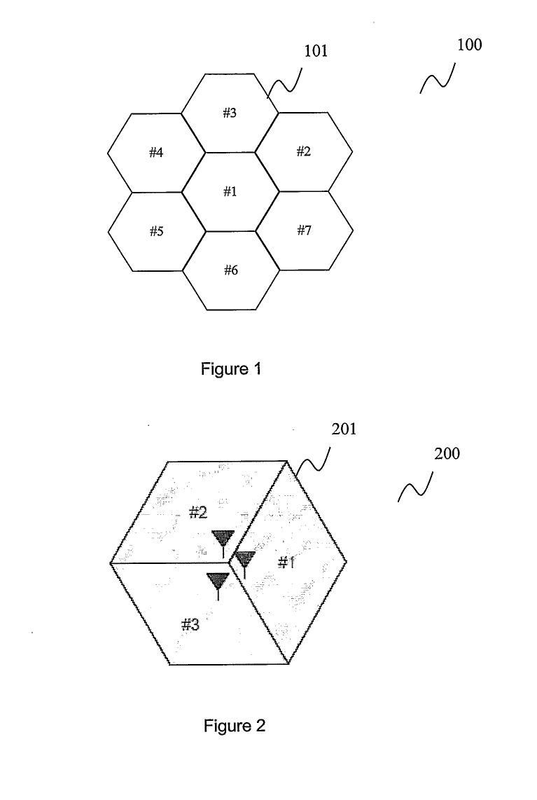

FIG. 2 shows an illustration of the sectorization of a cell in the cellular communication system according to an embodiment of the invention.

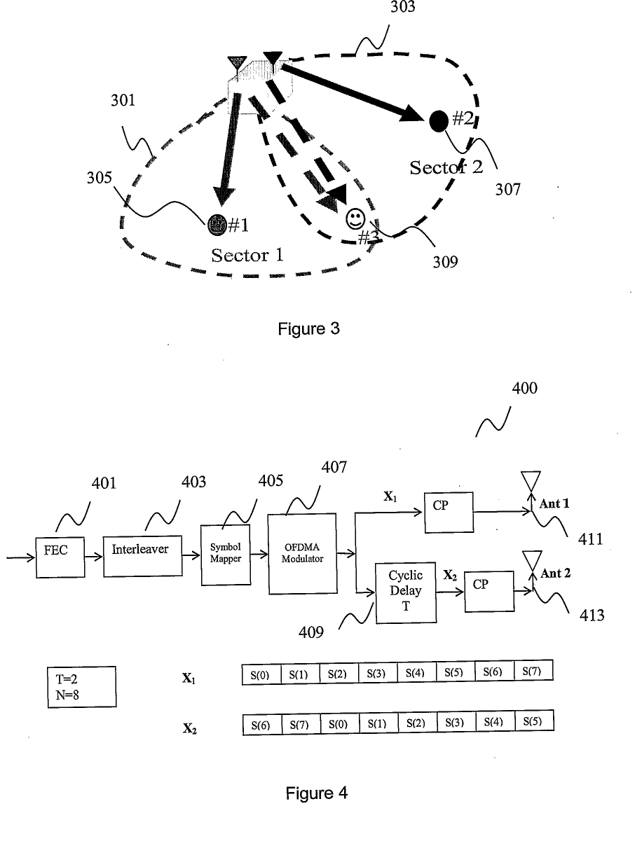

FIG. 3 shows an illustration of inter-sector interference in a sectorized cell in the communication system according to an embodiment of the invention.

FIG. 4 shows the block diagram of a transmitter according to an embodiment of the invention.

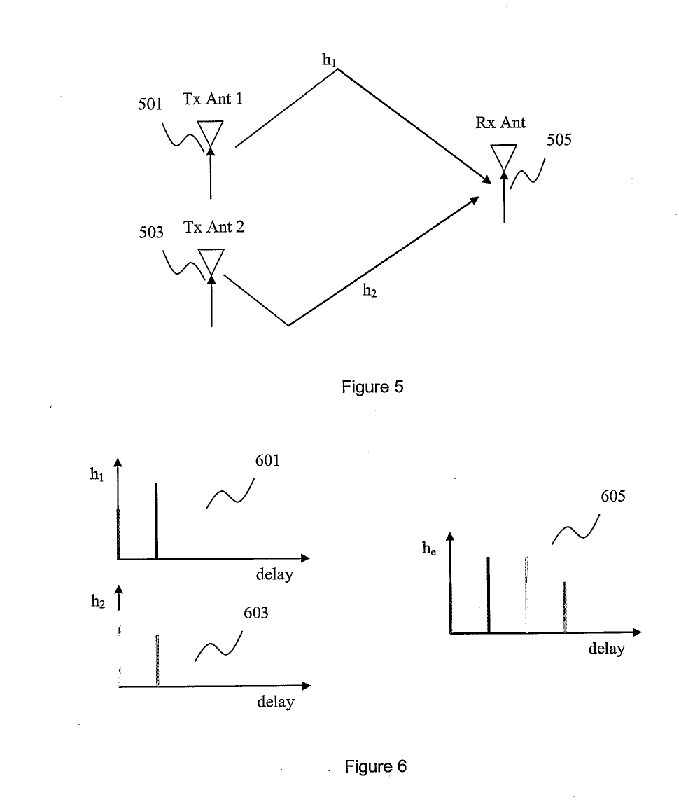

FIG. 5 shows the transmission model for a cellular communication system, with two transmit antennas, according to an embodiment of the invention.

FIG. 6 shows an equivalent of the composite model of the frequency responses as observed by the receive antenna, according to an embodiment of the invention.

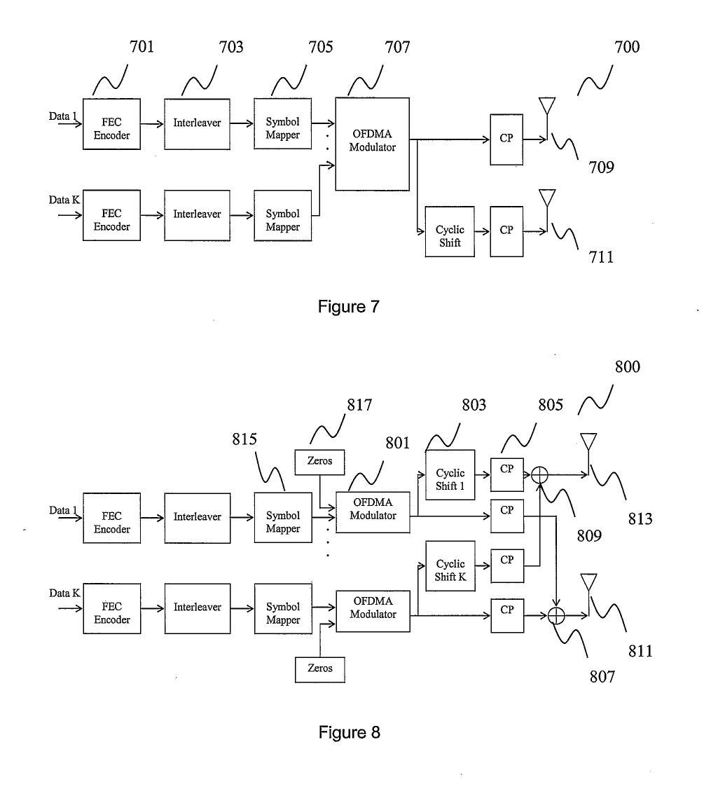

FIG. 7 shows the block diagram of a transmitter transmitting to a plurality of communication devices, according to an embodiment of the invention.

FIG. 8 shows the block diagram of a transmitter transmitting with different cyclic shifts to a plurality of communication devices according to an embodiment of the invention.

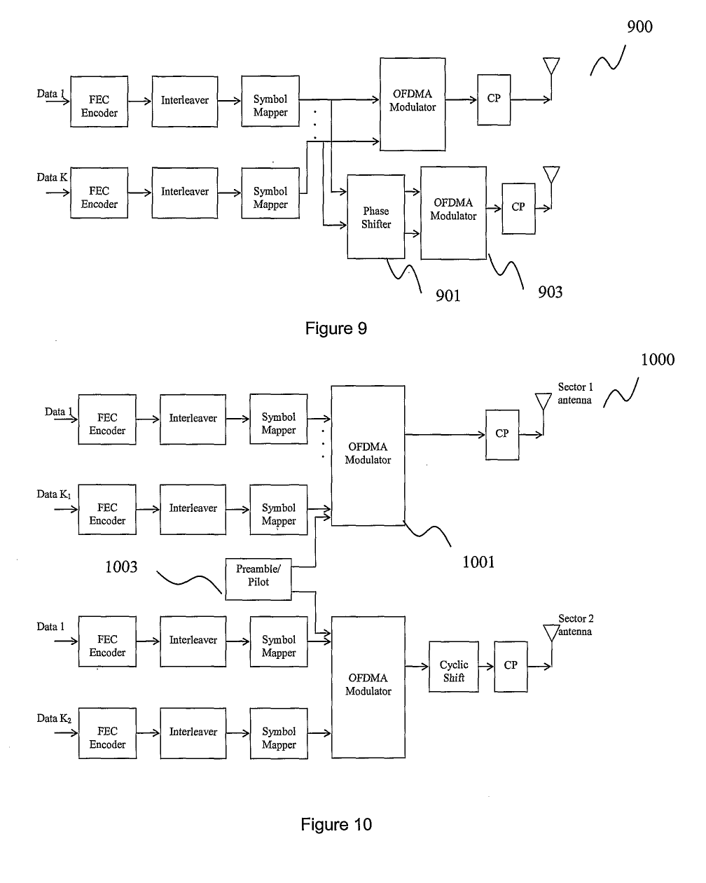

FIG. 9 shows the block diagram of a transmitter implemented using a frequency domain implementation according to an embodiment of the invention.

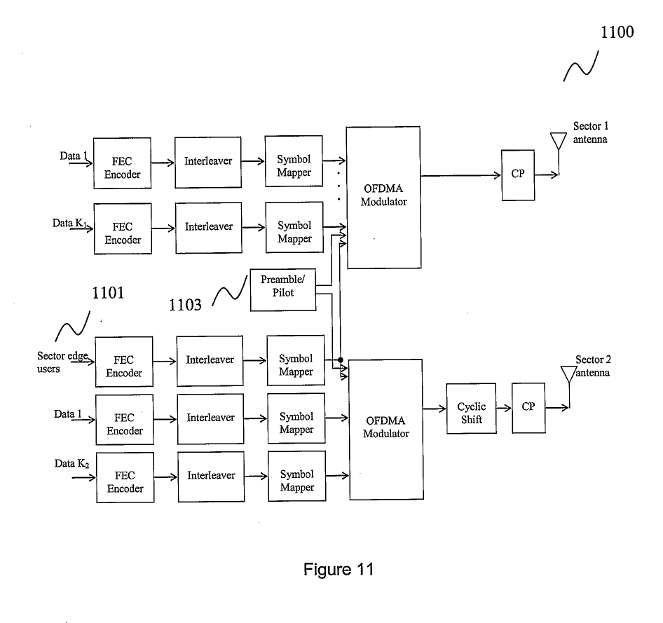

FIG. 10 shows the block diagram of a transmitter with a cyclic delayed transmission of data, preamble and pilot, according to an embodiment of the invention.

FIG. 11 shows another block diagram of a transmitter with a cyclic delayed transmission of data, preamble and pilot, according to an embodiment of the invention.

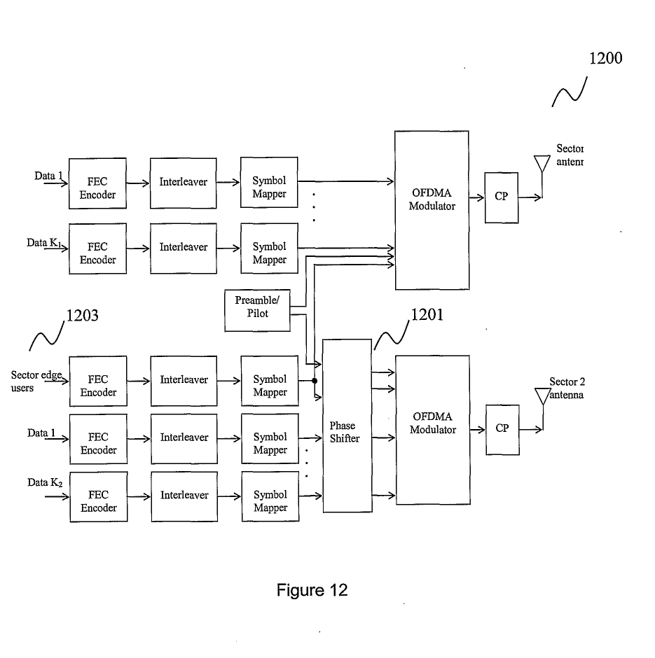

FIG. 12 shows the block diagram of a transmitter with a cyclic delayed transmission of data, preamble and pilot, implemented using a frequency domain implementation, according to an embodiment of the invention.

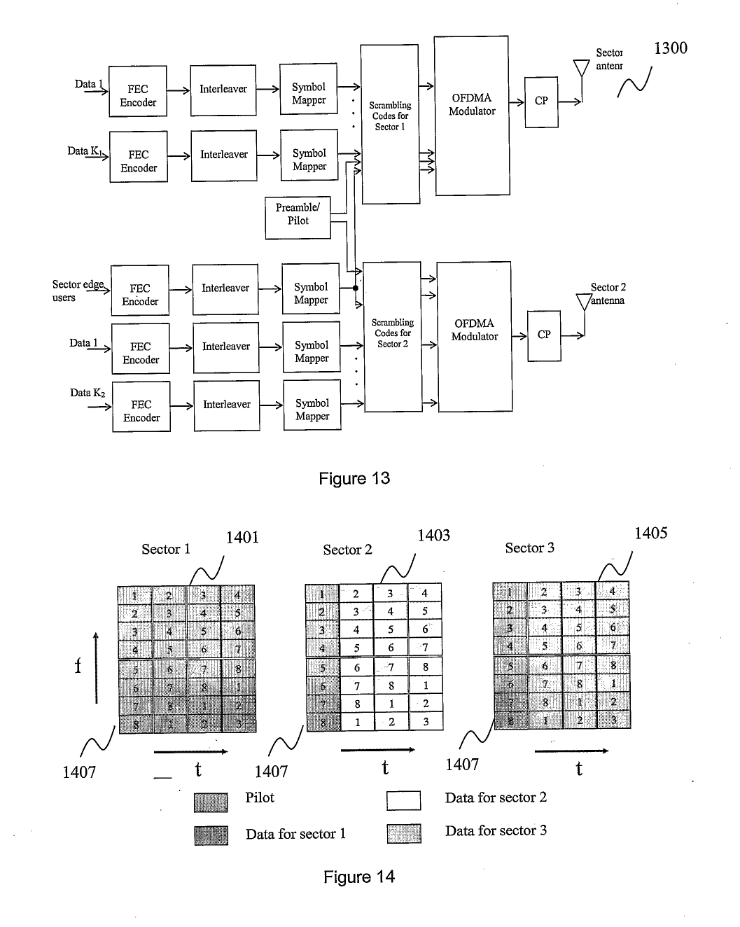

FIG. 13 shows another block diagram of a transmitter with a cyclic delayed transmission of data, preamble and pilot, implemented using a frequency domain implementation, according to an embodiment of the invention.

FIG. 14 shows an illustration of the preamble sequence and the pilot sequence designed for three sectors of the same cell, according to an embodiment of the invention.

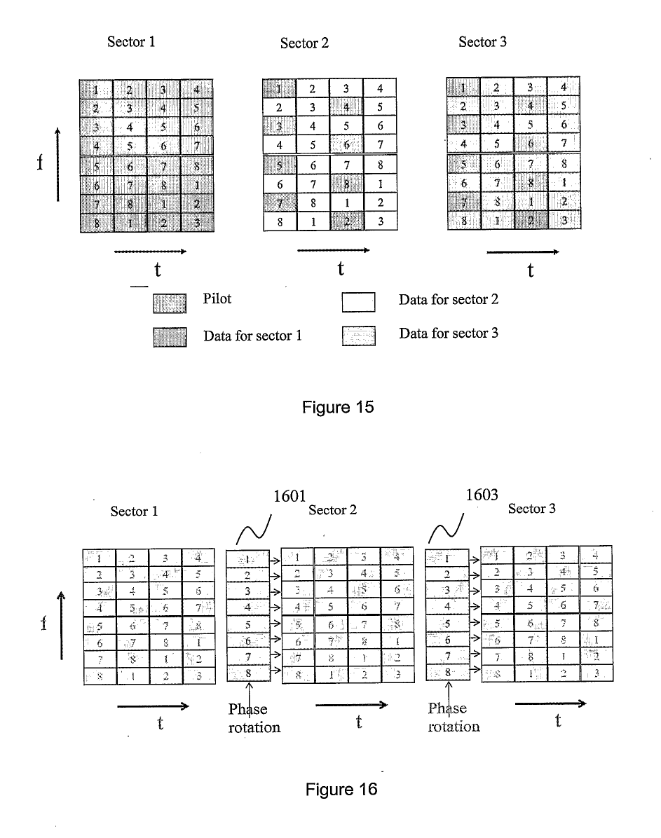

FIG. 15 shows an illustration of the scattered pilot sequence designed for three sectors of the same cell, according to an embodiment of the invention.

FIG. 16 shows the generation of scrambling codes for each sector of the same cell, according to an embodiment of the invention.

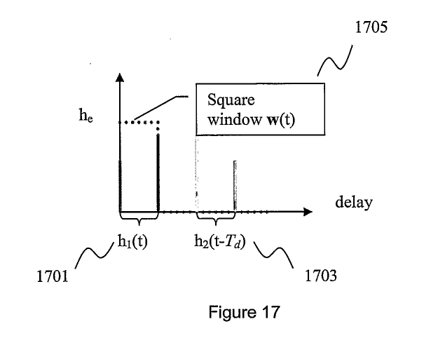

FIG. 17 shows an illustration of channel estimation, according to an embodiment of the invention.

FIG. 1 shows a cellular communication system 100 according to an embodiment of the invention.

In this illustration, the cellular communication system 100 comprises a plurality of cells 101. Each cell may, for example, be equipped with appropriate infrastructure to support the signal transmission to and from multiple communication devices simultaneously. The appropriate infrastructure, for example, may be a base station and a plurality of antennas.

Each cell may use one or more frequency bands. Alternatively, more than one cell may use one frequency band. Accordingly, the frequency band used by a cell may be different from, or the same as, the frequency band used by its adjacent cells.

In the case where the frequency band used by a cell is different from the frequency band used by its adjacent cells, some form of frequency planning is required. Frequency planning is a complex and time-consuming process.

In the case where the frequency band used by a cell is the same as the frequency band used by its adjacent cells, no frequency planning is required. However, there is inter-cell interference among the cells, and advanced signal processing techniques are required to reduce the effects of this interference on signal transmission.

According to one embodiment, the cellular communication system 100 may use a multiple access technology, which, for example, may be time division multiple access (TDMA), frequency division multiple access (FDMA), code division multiple access (CDMA) or orthogonal frequency division multiple access (OFDMA).

Next, an orthogonal frequency division multiple access (OFDMA) based cellular communication system is used as an illustration of an embodiment of the invention. Orthogonal frequency division multiple access (OFDMA) is a multi-carrier based multiple access technology, which used in IEEE802.16 WiMAX standard. In addition, orthogonal frequency division multiple access (OFDMA) is considered as a multiple access technology candidate for the Third Generation (3G) Long Tem Evolution (LTE) cellular systems and IEEE 802.22 wireless regional area network (WRAN).

In orthogonal frequency division multiple access (OFDMA), a frequency band is divided into a number of orthogonal sub-carriers. Each communication device in the cell is allocated with a different non-overlapping set of sub-carriers. A group of sub-carriers is known as a sub-channel.

Multi-user diversity may be achieved if the sub-carriers are properly allocated to the communication devices (or users). With multi-user diversity, it is possible to have an increased overall system throughput. In order to support an even larger number of users within the cell, sectorization may be applied.

FIG. 2 shows an illustration of the sectorization of a cell 200 in the cellular communication system according to an embodiment of the invention.

In this illustration, a cell 200 is divided into 3 sectors 201. Each sector may have a sector antenna with a 3-dB beamwidth of 120°.

With the sectorization performed as shown in FIG. 2, a capacity gain of factor 3 may be achieved when compared to the case without any sectorization. This means that the maximum number of users that may be supported by a cell sectorized in this manner is 3 times more than in the case without any sectorization.

FIG. 3 shows an illustration of inter-sector interference in a sectorized cell in the communication system according to an embodiment of the invention.

FIG. 3 shows two adjacent sectors, Sector 1 301 and Sector 2 303. There are 3 communication devices shown in FIG. 3, namely, communication device #1 305, communication device #2 307, and communication device #3 309. Communication device #3 309 is located in area where there is an overlap in the coverage of the signal transmission from Sector 1 301 and from Sector 2 303. Such an area will be called a sector edge in subsequent description.

As both the signal transmissions from Sector 1 301 and Sector 2 303 are in the same frequency band, the signal from Sector 1 301 interferes with the signal from Sector 2 303. This interference is typically known as inter-sector interference.

Due to the inter-sector interference, as shown in FIG. 3, the signal received by communication device #3 309 is degraded. Accordingly, the error rate in signal transmission to communication device #3 309 increases, which results in a lower throughput performance for communication device #3 309.

In order to increase the throughput for communication devices located near a sector edge, two adjacent sectors may be used to serve these communication devices simultaneously using the same set of sub-carriers. This approach is called inter-sector diversity, as used herein.

With reference to FIG. 3, in applying inter-sector diversity, transmit diversity techniques using at least two sector antennas may be applied to improve the throughput performance of communication device #3 309. In order to be able to use these transmit diversity techniques, several components of the transmitter as well as the sector antenna may be re-designed, including the preamble, the pilot symbol, the pilot sequence and the scrambling code.

FIG. 4 shows the block diagram 400 of a transmitter according to an embodiment of the invention.

In order to achieve a diversity gain, data to be sent is encoded, in this example using a forward error correction (FEC) encoder 401 and an interleaver 403. The encoded data is then mapped into symbols using a symbol mapper 405. Following which, the encoded data symbols are formulated by an orthogonal frequency division multiple access (OFDMA) modulator 405.

In the example shown in FIG. 4, the orthogonal frequency division multiple access (OFDMA) symbol size N=8, and the cyclic delay T=2, are selected. The transmitted orthogonal frequency division multiple access (OFDMA) symbol via a first antenna, antenna 1 (Ant 1) 411 is given by

x₁=[s(0),s(1),s(2),s(3),s(4),s(5),s(6),s(7)].

The cyclic delayed version of x₁, which is obtained by processing x₁ through the cyclic delay block 409, is given by

x₂=[s(6),s(7),(0),s(1),s(2),s(3),s(4),s(5)].

The cyclic delayed version of x₁, x₂, is transmitted through a second antenna, antenna 2 (Ant 2) 413. Accordingly, the transmission through antenna 2 (Ant 2) may be called a cyclic delayed transmission. Since both antennas convey the same set of data symbols, a diversity gain may be achieved.

FIG. 5 shows the transmission model for a cellular communication system with two transmit antennas according to an embodiment of the invention.

In this illustration, there are 2 transmit antennas, which for example may be the transmit antennas shown in FIG. 4, transmit antenna 1 (Tx Ant 1) 501 and transmit antenna 2 (Tx Ant 2) 503, and one receive antenna (Rx Ant) 505. The channel responses with respect to transmit antenna 1 (Tx Ant 1) 501 and transmit antenna 2 (Tx Ant 2) 503, are denoted as h₁(0), . . . , h₁(L−1) and h₂(0), . . . , h₂(L−1) respectively, where L is the number of channel delay taps. The respective frequency responses corresponding to transmit antenna 1 (Tx Ant 1) 501 and transmit antenna 2 (Tx Ant 2) 503, are H₁(0), . . . , H₁(N−1) and H₂(0), . . . , H₂(N−1).

The frequency responses of the composite channel observed by the receive antenna (Rx Ant) 505 is given by

$${H}_{e} ( k ) = {H}_{1} ( k ) + {H}_{2} ( k ) {e}^{- j \frac{2 π Tk}{N}} , \qquad ( 1 )$$

where k is the sub-carrier index, and T is the cyclic delay in symbols used in the second antenna. The cyclic delay is typically in the range [0, N].

In another representation, the composite channel response with 2 transmit antennas is shown in FIG. 6, where the original channel responses associated with each antenna is L=2, and cyclic delay is T=2. The original channel response corresponding to transmit antenna 1 is labeled 601, the original channel response corresponding to transmit antenna 2 is labeled 603, and the composite channel response corresponding to transmit antenna 1 and transmit antenna 2 is labeled 605.

With the cyclic delayed transmission, the composite channel response effectively becomes h₁(0),h₁(1),h₂(0),h₂(1), and the number of channel taps in the ‘virtual’ composite channel is increased to 4. This delay diversity may be further used to enhance the performance of the system, by employing cross band coding, for example. Although the number of delay taps of the ‘virtual’ composite channel is 4, the physical channel delays associated with both antennas remain unchanged at 2.

The cyclic delayed transmission provides the following advantage. Unlike conventional delay diversity, the cyclic delayed transmission does not increase the physical delay of the composite channel. Therefore, the minimum required cyclic prefix length remains unchanged at 1 symbol interval.

In the illustration shown in FIG. 5, the frequency domain representation of the data symbol on the k^{th} sub-carrier transmitted through transmit antenna 1 (Tx Ant 1) 501 and transmit antenna 2 (Tx Ant 2) 503 are S(k) and

$$S ( k ) {e}^{- j \frac{2 π Tk}{N}} ,$$

respectively. Therefore, the cyclic delayed transmission may be implemented by phase shifting the k^{th} data symbol by

$${e}^{- j \frac{2 π Tk}{N}}$$

prior to orthogonal frequency division multiple access (OFDMA) modulation for the transmit antenna 2 (Tx Ant 2) 503.

In the illustration shown in FIGS. 4 and 5, there is only receive antenna (Rx Ant) 505 represented. This means that there may be only one communication device, corresponding to the receive antenna (Rx Ant) 505. In a sectorized cell, typically there is more than one communication device. Accordingly, a more representative illustration is shown in FIG. 7.

FIG. 7 shows the block diagram 700 of a transmitter transmitting to a plurality of communication devices, according to an embodiment of the invention.

Each data stream, which is to be transmitted to their respective communication devices, is separately encoded and modulated. Accordingly, each data stream is processed by its own forward error correction (FEC) encoder 701, interleaver 703 and symbol mapper 705. The orthogonal frequency division multiple access (OFDMA) symbol is then formulated at the orthogonal frequency division multiple access (OFDMA) modulator 705, by collecting the symbols to be transmitted to the respective communication devices on the respective sub-carriers. In the time domain representation, the orthogonal frequency division multiple access (OFDMA) symbols are then transmitted using the first antenna 709, while the cyclic delayed orthogonal frequency division multiple access (OFDMA) symbols are transmitted using the second antenna 711.

The transmitted signals pass through different multipath channels, before reaching their respective communication devices. The equivalent channel observed from one communication device is the same as shown by Equation (1), except that each communication device will have its own channel responses.

In the illustration shown in FIG. 7, the same cyclic delay is applied to the signal transmission through transmit antenna 2 711 to all communication devices. However, it is also possible to apply different cyclic delays to the signal transmission through transmit antenna 2 711 to different communication devices. This is illustrated as shown in FIG. 8.

FIG. 8 shows the block diagram 800 of a transmitter transmitting with different cyclic shifts to a plurality of communication devices according to an embodiment of the invention.

In this illustration, in order to apply different cyclic delays to the signal transmission through transmit antenna 2 711 to different communication devices, additional components are used. For example, for processing the data for each communication device, one orthogonal frequency division multiple access (OFDMA) modulator 801, one cyclic delay block 803 and 2 cyclic prefix (CP) blocks are used.

Once the data signals for all communication devices have been processed, they are added together by respective adding units (807 and 809) and then transmitted via transmit antenna 1 811 and transmit antenna 2 813 respectively.

In FIG. 8, it is possible that the output of the symbol mapper 815 does not occupy all the sub-carriers. When this happens, the unoccupied sub-carriers are then inserted with zeros provided by the zeros block 817.

Next, the cyclic delayed transmission using the frequency domain implementation is described. The frequency domain implementation is based on the equivalence between time domain and frequency domain.

FIG. 9 shows the block diagram 900 of a transmitter implemented using a frequency domain implementation according to an embodiment of the invention.

In this illustration, the cyclic delay block, used in the time domain implementation, is replaced by a phase shifter 901. In addition, the phase shifter 901 is placed before the orthogonal frequency division multiple access (OFDMA) modulator 903. In the time domain implementation, the cyclic delay block is placed after the orthogonal frequency division multiple access (OFDMA) modulator (see for example FIG. 7).

Assuming that communication device k is allocated with sub-carrier index set A(k), and the cyclic delay for communication device k is Tₖ. In the frequency domain implementation, the frequency of the signal to be transmitted to communication device k through the second antenna is modulated with a phase shifter

$$exp ( - j2π \frac{{T}_{k} l}{N} ) ,$$

where lεA(k).

The frequency domain implementation provides the following advantages. Firstly, in a downlink transmission, different sub-channels will typically have different channel responses. Accordingly, the cyclic delay requirements for the different sub-channels will also different. Therefore, by using the frequency domain implementation, the different cyclic delay requirements can be met accordingly for each communication device.

Secondly, for the frequency domain implementation, the number of orthogonal frequency division multiple access (OFDMA) modulators needed depends on the number of transmit antennas used. In general, when the number of transmit antennas used is i, then i orthogonal frequency division multiple access (OFDMA) modulators are needed. Therefore, in the illustration shown in FIG. 9, since there are only two transmit antennas, only two orthogonal frequency division multiple access (OFDMA) modulators are needed.

In contrast to the time domain implementation, the number of orthogonal frequency division multiple access (OFDMA) modulators needed depends on the number of communication devices that can be supported by one orthogonal frequency division multiple access (OFDMA) symbol. In the illustration shown in FIG. 7 (which is the corresponding time domain implementation illustration for the illustration shown in FIG. 9), the number of communication devices that can be supported by one orthogonal frequency division multiple access (OFDMA) symbol is K, therefore K orthogonal frequency division multiple access (OFDMA) modulators are needed.

Since the number of communication devices that can be supported by one orthogonal frequency division multiple access (OFDMA) symbol is typically larger than the number of transmit antennas used, the frequency domain implementation requires a lesser number of orthogonal frequency division multiple access (OFDMA) modulators, compared to the time domain implementation.

Thus far, only the data transmission is considered in the cyclic delayed transmission. In addition, it is also implied that the two transmit antennas send the same set of modulated symbols to a communication device. In practice, this is generally not true, especially in an inter-sector environment. This is because each sector antenna needs to cater to the communication devices within its own sector. Accordingly, the transmitted signals from different sector antennas are usually different. Also, in order to assist for the synchronization (time, frequency, etc) and signal detection processes at the communication device, the preamble sequence and pilot sequence to be transmitted are specific to each sector. Accordingly, the preamble sequence and the pilot symbol transmission must be considered in the cyclic delayed transmission as well.

FIG. 10 shows the block diagram 1000 of a transmitter with a cyclic delayed transmission of data, preamble and pilot, according to an embodiment of the invention.

In this illustration, an additional component is added before the orthogonal frequency division multiple access (OFDMA) modulator 1001, namely the preamble sequence and the pilot sequence generator block 1003.

In this illustration, K₁ and K₂ denote the number of communication devices served simultaneously in sector 1 and sector 2, respectively. In this case, the preamble and pilot occupy the same set of sub-carriers in both sectors, and in each of the preamble and the pilot sub-carriers, the modulated symbols are the same for both sectors.

In contrast to the transmitter shown in FIG. 7, the preamble sequence and the pilot sequence are now cyclic delayed.

For communication devices located at the sector edge, they are able to receive signals from both sector antennas, thus the cyclic delayed transmission is useful to them. However, for communication devices located, say in the middle of the sector, they can only receive signal from one sector antenna, and thus the cyclic delayed transmission is of no benefit to them.

FIG. 11 shows another block diagram 1100 of a transmitter with a cyclic delayed transmission of data, preamble and pilot, according to an embodiment of the invention.

It can be seen from this illustration that the data signal for a communication device at the sector edge 1101 is processed in the same way as the data signal for all other communication devices.

In this illustration, the preamble sequence and the pilot sequence occupy the same set of sub-carriers for both two sectors, and the same preamble sequence and pilot sequence 1103 are used for each sub-carrier. Also, the communication devices at the sector edge all occupy the same set of sub-carriers.

In this case, the preamble sequence, pilot sequence and signals for communication devices at the sector edge are all cyclic delayed. Communication devices located, say in the middle of the sector, can only receive signal from one sector antenna, and thus the cyclic delayed transmission is of no benefit to them.

FIG. 12 shows the block diagram 1200 of a transmitter with a cyclic delayed transmission of data, preamble and pilot, implemented using a frequency domain implementation, according to an embodiment of the invention.

In this illustration, the preamble sequence and the pilot sequence occupy the same set of sub-carriers for both two sectors, and the same preamble sequence and pilot sequence are used for each sub-carrier. Also, the communication devices at the sector edge all occupy the same set of sub-carriers.

In contrast to the illustration in FIG. 11, in the frequency domain implementation, the phase shifter 1201 is used to replace the cyclic delay (of the time domain implementation).

Assuming that communication device k is allocated with sub-carrier index set A(k), and the cyclic delay for communication device k is Tₖ. In the frequency domain implementation, the frequency of the signal to be transmitted to communication device k through the second antenna is modulated with a phase shifter

$$exp ( - j2π \frac{{T}_{k} l}{N} ) ,$$

where lεA(k).

It can be seen from this illustration that the data signal for a communication device at the sector edge 1203 is processed in the same way as the data signal for all other communication devices.

FIG. 13 shows another block diagram 1300 of a transmitter with a cyclic delayed transmission of data, preamble and pilot, implemented using a frequency domain implementation, according to an embodiment of the invention.

This illustration is the same as the illustration shown in FIG. 13, except that here, different sets of scrambling codes are used for different sectors. In this illustration, the preamble sequence and the pilot sequence occupy the same set of sub-carriers for both two sectors, and the same preamble sequence and pilot sequence are used for each sub-carrier. Also, the communication devices at the sector edge all occupy the same set of sub-carriers.

In this illustration, the scrambling codes used in sector 2 are generated by multiplying the scrambling codes used in sector 1 with the phase shifter. The process of generating the scrambling codes used in sector 2 will be described subsequently in conjunction with FIG. 16.

Assuming that communication device k is allocated with sub-carrier index set A(k), and the cyclic delay for communication device k is Tₖ. In the frequency domain implementation, the frequency of the signal to be transmitted to communication device k through the second antenna is modulated with a phase shifter

$$exp ( - j2π \frac{{T}_{k} l}{N} ) ,$$

where lεA(k).

It can be seen that in contrast to FIGS. 9 and 12 which show frequency domain implementations, FIG. 13 does not have a phase shifter. This is because the phase shifting has already been carried out on the scrambling codes used in sector 2, which will be further described in relation to FIG. 16.

As mentioned earlier, the preamble sequence and the pilot sequence are needed for time and frequency synchronization, as well as channel estimation. Accordingly, the preamble sequence and the pilot sequence are specially designed for all sectors within the cell. The design of the preamble sequence and the pilot sequence is described next using the pilot sequence as an illustration in FIGS. 14 and 15.

FIG. 14 shows an illustration of the pilot sequence designed for three sectors of the same cell, according to an embodiment of the invention.

In this illustration, there are three signal transmissions, the transmission from sector 1 antenna 1401, the transmission from sector 2 antenna 1403, and the transmission from sector 3 antenna 1405.

The first orthogonal frequency division multiple access (OFDMA) symbol for the transmission from all sector antennas 1407 is allocated as the pilot in all three sectors.

The design rule for a preamble sequence or a pilot sequence suitable for cyclic delayed transmission is given as follows. In any given sub-carrier k, the modulated symbols must be the same for all three sectors. However, from one sub-carrier to another, the modulated symbols may be different.

FIG. 15 shows an illustration of the scattered pilot sequence designed for three sectors of the same cell, according to an embodiment of the invention.

In this illustration, all sectors use the same pilot sequence. Even though the pilot sequence is not the first orthogonal frequency division multiple access (OFDMA) symbol in each sector transmission (as shown in FIG. 14), the design rule described earlier still holds in this illustration.

FIG. 16 shows the generation of scrambling codes for each sector of the same cell, according to an embodiment of the invention.

In this illustration, sector 1 is used as the reference sector.

There are different ways to generate the scrambling codes. For example, the scrambling codes may be randomly generated for the first orthogonal frequency division multiple access (OFDMA) symbol, and then the scrambling codes for subsequent orthogonal frequency division multiple access (OFDMA) symbols are chosen as the cyclically delayed versions of scrambling codes of symbol 1. This is based on a time domain implementation.

Accordingly, in a frequency domain implementation, the preamble sequence, the pilot sequence and the data to be transmitted to communication devices located at the sector edge, the scrambling codes for sectors 2 and 3 are generated using the scrambling codes of sector 1 scaled by the phase shifters, which are related to the time domain cyclic delays of the users. The phase shifter for sector 2 1601 and the phase shifter for sector 3 1603 are as shown in FIG. 16.

Assuming that communication device k is allocated with sub-carrier index set A(k), and the cyclic delay for communication device k is Tₖ. In the frequency domain implementation, the frequency of the signal to be transmitted to communication device k through the second antenna is modulated with a phase shifter

$$exp ( - j2π \frac{{T}_{k} l}{N} ) ,$$

where lε(A(k).

This scrambling code generated in this manner may be used in conjunction with the frequency domain implementation, shown in FIG. 13.

Next, the channel estimation procedure is described. In the subsequent description, the following notations are used.

h₁=[h₁(0), h₁(1), . . . , h₁(L)] is the time domain channel from the current sector antenna to the mobile user;
H₁=[H₁(1), H₁(2), . . . , H₁(N)] is the frequency domain channel from the current sector antenna to the mobile user;
h₂=[h₂(0), h₂(1), . . . , h₂(L)] is the time domain channel from the interfering sector antenna to the mobile user;
H₂=[H₂(1), H₂(2), . . . , H₂(N)] is the frequency domain channel from the interfering sector antenna to the mobile user;
s=[s(1), s(2), . . . , s(N)] is the frequency domain common pilot sequence that are common to all three sectors;
d₁=[d₁(1), d₁(2), . . . , d₁(N)] is the frequency domain data signal of the mobile user;
φ is the phase difference between the scrambling codes of the two sectors; and
T_{d} is the cyclic delay between the two sectors due to the phase difference φ=2πT_{d}/N

The channel estimation procedure may be classified into three classes, which depends on the position of the communication device and the mode in which the communication device is currently operating:
a) communication devices not at the sector edge,
b) communication devices at the sector edge operating in the diversity mode,
c) communication devices at the sector edge operating in the normal mode.

For the communication devices not at the sector edge, the channel estimation may be performed as normal, since there are no interfering communication devices from the other sectors.

For communication devices at the sector edge operating in the diversity mode, two adjacent sectors are transmitting concurrently the same data and pilot sequence to the communication device, with a phase difference exp(−jnφ) where n is the sub-carrier index. The received pilot signal on sub-carrier k may be written as

r(k)=H₁(k)s(k)+H₂(k)exp(−jkφ)s(k)+n(k)=[H₁(k)+H₂(k)exp(−jkφ)]s(k)+n(k)

Accordingly, the effective channel Hₑ(k)=H₁(k)+H₂(k) exp(−jkφ) may be estimated using the normal channel estimation algorithm. As the same data is transmitted from the two sector antennas in the same manner as the pilot sequence, the received data is subjected to the same effective channel Hₑ, which has effectively 2(L+1) taps, provided T_{d}>L+1. Therefore, the frequency diversity of communication devices at the sector edge operating in diversity mode is increased and better performance may be achieved.

Also, since the pilot sequence and the data are subject to the same effective channel, the diversity transmission mode is transparent to the user.

For communication devices at the sector edge operating in the normal mode, the communication device is receives signals from two sector antennas concurrently. However, it is associated with only one sector antenna. The received signal in the pilot channel is the same as the communication devices at the sector edge operating in the diversity mode, i.e.,

r(k)=H₁(k)s(k)+H₂(k)exp(−jkφ)s(k)+n(k)=[H₁(k)+H₂(k)exp(−jkφ)]s(k)+n(k)

Using the normal channel estimation algorithm, the estimated channel is the effective channel Hₑ(k)=H₁(k)+H₂(k)exp(−jkφ). The equivalent time domain channel is given by hₑ(t)=h₁(t)+h₂(t−T_{d}), where the channel response corresponding to transmit antenna 1 h₁(t) 1701 and the channel response corresponding to transmit antenna 2 h₂(t−T_{d}) 1703 are illustrated as shown in FIG. 17. The relationships between hₑ(t), h₁(t) and h₂(t) are as is illustrated in FIG. 6.

However, as the communication device is operating in the normal mode, the desired data signal is transmitted only from one sector antenna. The received data signal in this case can be expressed as:

r(k)=H₁(k)d₁(k)+H₂(k)exp(−jkφ)I(k)+n(k),

where I(k) is the interfering data signal from some other users in the adjacent sector. For the communication device is operating in the normal mode, in order to recover the desired data, an estimate of H₁ is needed rather than Hₑ, or equivalently, h₁ rather than hₑ.

Appropriate signal processing techniques may be used to get h₁ from hₑ or H₁ from Hₑ. For example, one way is to multiply hₑ with a square window function w(t) 1705 defined as

$$w ( t ) = \{ \begin{matrix}1 & t = 0 , 1 , 2 , … , L \\ 0 & t > L .\end{matrix}$$

Here, h₁(t)=hₑ(t)w(t), where the square window function w(t) 1705 is illustrated as shown in FIG. 17.

In practice, channel estimation is typically performed in the frequency domain. In this case, the time domain windowing operation may be performed equivalently in the frequency domain, by circularly convolving Hₑ with the Fourier transform of w(t), f, which is a sinc function, i.e.,

H₁=Hₑ [symbol] f.

It can be seen that this operation resembles with the robust MMSE channel estimation.

In this description, 2 transmit antennas have been used for illustrating the cyclic delayed transmission, and 3 sectors have been used for illustrating the designing of the preamble sequence and the pilot sequence. Accordingly, the schemes described here may be applied to more than 2 transmit antennas, and more than 3 sectors, as well.

For example, if each sector has more than one antenna, other signal processing techniques, such as space time processing techniques, may be carried out using the additional antennas. If the communication devices also have multiple antennas, other signal processing techniques, such as spatial multiplexing, may also be applied to increase the transmission data rate.

In this document, the following publication is cited:
[1] “A PHY/MAC Proposal for IEEE 802.22 WRAN System, Part 2: The Cognitive MAC”, by ETRI, FT, HuaWei, I2R, Motorola, NextWave, Philips, Runcom, Samsung, STM, Thomson, March 2006.

What is claimed is:

1. A method for transmitting a signal to a communication device in a cellular communication system, comprising
transmitting a signal using a first antenna being provided in a first sector of the cellular communication system; and
transmitting another signal using a second antenna being provided in a second sector of the cellular communication system, wherein the first sector at least partially overlaps the second sector,
wherein the signal transmitted by the second antenna is a cyclic delayed version of the signal transmitted by the first antenna.

2. The method of claim 1, wherein the signal transmitted by the first antenna being cyclic shifted in order to obtain the cyclic delayed version of the signal transmitted by the first antenna, to be transmitted on the second antenna.

3. The method of claim 1, wherein the signal transmitted by the second antenna being phase shifted in order to obtain the cyclic delayed version of the signal transmitted by the first antenna, to be transmitted on the second antenna.

4. The method of claim 1, further comprising inserting a preamble and/or a pilot sequence into the signal transmitted by the second antenna.

5. The method of claim 1, further comprising adding a scrambling code to the signal transmitted by the second antenna.

6. The method of claim 1, further comprising carrying out a channel estimation.

7. The method of claim 1, wherein the communication device is a radio communication device.

8. The method of claim 7, wherein the communication device is a mobile radio communication device.

9. The method of claim 7, wherein the communication device is a mobile radio base station.

10. The method of claim 1, wherein the communication device is a terminal communication device.

11. The method of claim 1, wherein the communication device is a Consumer Premise Equipment device.

12. The method of claim 1, further comprising
using a multiple access transmission technology.

13. The method of claim 12,
the multiple access transmission technology being selected from a group of multiple access transmission technologies consisting of:
time division multiple access,
frequency division multiple access,
code division multiple access,
orthogonal frequency division multiple access.

14. A system for transmitting a signal to a communication device in a cellular communication system, comprising
a plurality of antennas; and
a signal transmission device, comprising
a first signal generator for generating a signal to be transmitted using a first antenna being provided in a first sector of the cellular communication system; and
a second signal generator for generating a signal to be transmitted using a second antenna being provided in a second sector of the cellular communication system, wherein the first sector at least partially overlaps the second sector,
wherein the signal transmitted by the second antenna is a cyclic delayed version of the signal transmitted by the first antenna.

15. The system of claim 14, wherein the signal transmission device comprising
an orthogonal frequency division multiple access (OFDMA) modulator; and
a cyclic delay unit,
wherein the cyclic delay unit is used to generate a cyclic delayed version of the signal transmitted by the first antenna, for transmission on the second antenna.

16. The system of claim 15, wherein the cyclic delay unit is a cyclic delay device.

17. The system of claim 16, wherein the cyclic shift device is arranged such that the signal to be transmitted on the second antenna is processed by the orthogonal frequency division multiple access (OFDMA) modulator before being processed by the cyclic shift device.

18. The system of claim 15, wherein the cyclic delay unit is a phase shifter device.

19. The system of claim 18, wherein the phase shifter device is arranged such that the signal to be transmitted on the second antenna is processed by the phase shifter device before being processed by the orthogonal frequency division multiple access (OFDMA) modulator.

20. The system of claim 15, wherein the signal transmission device further comprising
a pilot sequence generator; and
a preamble generator.

21. The system of claim 14, wherein the signal transmission device further comprising
a scrambling code generator.
